(19) United States
(12) Patent Application Publication
(10) Pub. No.: US 2026/0142461 A1
(43) Pub. Date: May 21, 2026

(54) MICROGRID ENERGY MANAGEMENT SYSTEM

(71) Applicant: Robert Bosch GmbH, Stuttgart (DE)

(72) Inventors: Alexander John VAN-BRUNT, Sunnyvale, CA (US); Jonathan BRAATEN, Sunnyvale, CA (US); Bjoern STUEHMEIER, Santa Clara, CA (US); Lei CHENG, Sunnyvale, CA (US); Felipe MOJICA, Sunnyvale, CA (US); Shirin MEHRAZI, Sunnyvale, CA (US); John CHRISTENSEN, Elk Grove, CA (US)

(21) Appl. No.: 18/954,012

(22) Filed: Nov. 20, 2024

(51) Int. Cl. H02J 3/00; C25B 9/70; C25B 15/02; H02J 3/38

(52) U.S. Cl. CPC H02J 3/003; C25B 9/70; C25B 15/02; H02J 3/004; H02J 3/38; H02J 2101/20; H02J 2103/30

(57) ABSTRACT

An energy management system for microgrid systems. The energy management system includes a controller. The controller is configured to receive forecasted weather condition data, predict a power generation profile and/or a power demand profile of a microgrid system in response to the forecasted weather condition data, determine a performance model and/or a degradation model of one or more system components of the microgrid system in response to the power generation profile and/or the power demand profile, derive an energy management optimization strategy in response to the performance model and/or the degradation model of the one or more system components of the microgrid system, and control an operation mode of the one or more system components of the microgrid system in response to the energy management optimization strategy.

### TECHNICAL FIELD

The present disclosure relates to a microgrid energy management system. The microgrid energy management system may integrate weather forecast data with operational strategies for electrolyzer stacks in microgrids.

### BACKGROUND

Electrolyzer systems including electrolyzer stacks are capable of clean hydrogen production. The input into an electrolyzer stack is water, which is an environmentally friendly and abundant material. The electrolyzer system uses electricity to split water molecules. Hydrogen ions receive electrons from the electricity to form hydrogen gas (H₂) at a cathode and oxygen gas (O₂) is produced as a byproduct at an anode. The electrolyzer stack produces no direct emissions—hydrogen gas may be used as a clean fuel source and the oxygen gas is released harmlessly into the atmosphere and may be used for other purposes.

The electricity used in the electrolyzer system may be produced by renewable energy sources. The use of renewable energy sources for the electricity production renders the process of hydrogen gas production from electrolyzer stacks emission-free, thereby promising clean hydrogen production.

### SUMMARY

According to one embodiment, an energy management system for microgrid systems is disclosed. The energy management system includes a controller. The controller is configured to receive forecasted weather condition data, predict a power generation profile and/or a power demand profile of a microgrid system in response to the forecasted weather condition data, determine a performance model and/or a degradation model of one or more system components of the microgrid system in response to the power generation profile and/or the power demand profile, derive an energy management optimization strategy in response to the performance model and/or the degradation model of the one or more system components of the microgrid system, and control an operation mode of the one or more system components of the microgrid system in response to the energy management optimization strategy.

According to a second embodiment, an energy management system for microgrid systems is disclosed. The energy management system includes a controller. The controller is configured to receive first forecasted weather condition data associated with a first microgrid system and second forecasted weather condition data associated with a second microgrid system, predict a first power generation profile and/or a first power demand profile of the first microgrid system in response to the first forecasted weather condition data and a second power generation profile and/or a second power demand profile of the second microgrid system in response to the second forecasted weather condition data, determine a first performance model and/or a first degradation model of the first microgrid system in response to the first power generation profile and/or the first power demand profile and a second performance model and/or a second degradation model of the second microgrid system in response to the second power generation profile and/or the second power demand profile, derive an overall energy management optimization strategy for the first microgrid system and the second microgrid system in response to the first performance model and/or the first degradation model and the second performance model and/or the second degradation model, and control a first operation mode of the first microgrid system and a second operation mode of the second microgrid system in response to the overall energy management optimization strategy. For example, the first microgrid system and the second microgrid system may be distinct microgrids deployed modularly and connected to a common energy management system and forecasting system for mutual optimization.

According to yet another embodiment, an energy management system for microgrid systems is disclosed. The energy management system includes a controller. The controller is configured to receive forecasted weather condition data associated with a microgrid system having a first electrolyzer stack of a first electrolyzer type and a second electrolyzer stack of a second electrolyzer type different than the first electrolyzer type, predict a first power generation profile of the first electrolyzer stack in response to the forecasted weather condition data and the first electrolyzer type and a second power generation profile of the second electrolyzer stack in response to the forecasted weather condition data and the second electrolyzer type, determine a first performance model and/or a first degradation model of the first electrolyzer stack in response to the first power generation profile and a second performance model and/or a second degradation model of the second electrolyzer stack in response to the second power generation profile, derive an overall energy management optimization strategy for the first electrolyzer stack and the second electrolyzer stack in response to the first performance model and/or the first degradation model and the second performance model and/or the second degradation model, and control a first operation mode of the first electrolyzer stack and a second operation mode of the second electrolyzer stack in response to the overall energy management optimization strategy.

### BRIEF DESCRIPTION OF THE DRAWINGS

FIG. 1 depicts a schematic diagram of an energy management system according to one or more embodiments.

FIG. 2A depicts a graph of a wind speed forecast graphing wind speed (Km/h) as a function of time of day.

FIG. 2B depicts a graph of a power generation profile graphing predicted power (kW) as a function of time of day.

FIG. 2C depicts a graph implementing an optimal electrolyzer stack and energy management optimization strategy and graphs electrolyzer (ELY) stack voltage (V) as a function of time of day.

FIG. 3 depicts an exemplar computing device that may be used in connection with an energy management system according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material and/or use are to be understood as modified by the word “about” in describing the broadest scope of the invention.

The first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

Hydrogen is a promising resource for shifting from a fossil fuel economy. However, fully realizing this promise requires economically viable and scalable methods of hydrogen production. Electrolyzer systems comprising electrolyzer stacks may become a key component in the hydrogen economy by providing a clean source of hydrogen production. Electrolyzer stacks may be constructed and implemented modularly. However, adoption of electrolyzer stacks has been encumbered by economic barriers, electricity intensive requirements, efficiency considerations, and durability issues.

At the same time of the emergence of hydrogen as a promising clean resource, the advent of widespread sources of renewable energy has led to increasing demand for energy storage systems that can efficiently harness these renewable energy sources. Microgrids are an energy storage system under consideration for these purposes due to its benefits of modularization, security, flexibility, and/or ease of transmission.

A combination of an electrolyzer system and a microgrid system has been proposed to offer a clean source of fuel production, energy storage and electricity within a single system. However, implementing this proposed solution has been challenging because a microgrid system relies on intermittent power sources that are irregular given the relatively small size of the microgrid. The intermittent nature of renewable energy sources, combined with the intensive energy demands of an electrolyzer stack, make dynamic operation of the electrolyzer stack an attractive economic option. For instance, a strategy may be implemented where an electrolyzer stack operates at high current densities in periods where renewable sources are plentiful and the electrolyzer stack runs near idle during periods of lower energy production. The high current density may be any of the following values or in a range of any two of the following values: 1.5, 1.6, 1.7, 1.8, 1.9, 2.0, 2.1, 2.2, 2.3, 2.4, and 2.5 A/cm². The current density of the electrolyzer stack running near idle may be 0.02, 0.03, 0.04, 0.05, 0.06, 0.07, 0.08, 0.09, and 0.1 A/cm².

However, dynamic operation of an electrolyzer stack may significantly accelerate degradation, particularly cycling between high and low voltages. In extreme cases, adverse weather may result in a halt of renewable production, thereby resulting in a shutdown of the electrolyzer stack, which may severely degrade the electrolyzer stack.

Additionally, the use of a combined microgrid and an electrolyzer stack in a purely reactive manner may either over or under produce the amount of energy stored relative to power generation that is to be expected, and therefore, further exacerbating dynamic swings in operation of the combined system. These dynamic swings may accelerate degradation of energy storage systems (e.g., batteries) used in the combined system. For example, a period of a week of good weather supporting high power generation with one day intermingled with very low generation may result in unnecessary dynamic operation of the electrolyzer stack as opposed to an energy storage strategy maintaining the electrolyzer stack at constant operation.

The consequence of this uncertainty of power generation from intermittent sources may result in a lower return on capital then may otherwise be possible. However, advances in artificial intelligence, increased availability and centralization data and deepened knowledge within the scientific community of electrolyzer stack performance and degradation mechanisms allows for opportunities for improved system design.

An electrolyzer stack may be powered by renewable energy sources such as solar power or wind power. However, effectively managing operation of the electrolyzer stack may be difficult when reliant on these renewable energy sources due to their intermittent nature. What is needed is an energy management system to effectively manage electrolyzer stacks powered by an intermittent renewable energy source.

In one or more embodiments, an energy management system for managing intermittent renewable energy sources is disclosed. The energy management system may include a controller configured to receive forecasted weather condition data and apply an energy management optimization strategy in response to the weather forecasting data to power the electrolyzer stack by an energy grid (e.g., a microgrid system). The microgrid system may be a localized, self-contained electrical network. The microgrid system may operate independent of a main power grid or may be connected to a main power grid. Independent operation may be referred to as an island mode. The microgrid system includes a power generation source. In one or more embodiments, the power generation source includes one or more renewable energy sources (e.g., solar panels and/or wind turbines). In one or more other embodiments, the power generation source includes both renewable energy sources and non-renewable energy sources (e.g., diesel generators and/or natural gas turbines).

The controller of the energy management system may use available weather data to predict the expected power available from renewable and/or intermittent sources. The available weather data may be used to adjust an operation strategy of the electrolyzer stack and/or an energy storage system (e.g., battery), which may be coupled to the electrolyzer stack. The energy management system may achieve one or more of the following benefits: improved hydrogen production, efficiency, uptake of renewable, dependability of the microgrid to meet forecast demand, minimizing degradation and/or meeting one or more key performance indicators (KPIs) of the system. KPIs of an electrolyzer stack may include, but are not limited to, hydrogen production rate, production efficiency, mean time between failures (MTBF), mean time to repair (MTTR), stack lifetime, start-up time, turndown ratio, and power consumption at idle. KPIs of an energy storage system may include, but are not limited to, nominal capacity, usable capacity, capacity degradation rate, maximum power output, response time, ramp rate, availability, MTBF, MTTR, and cycle efficiency. The energy management system may receive input from users to set a weighting between different KPIs for optimization (e.g., durability may be weighted more than efficiency).

In one or more embodiments, an energy management system is disclosed. The energy management system may manage operation of one or more components associated with a microgrid system (e.g., an electrolyzer stack, an energy storage system, etc.). The energy management system may use forecasted weather condition data to optimize operation of the one or more components associated with the microgrid system. A machine learning algorithm may be used to predict a power generation profile and/or a power demand profile over a time increment in a geographic scale in response to forecasted weather condition data and historical power generation profiles and/or power demand profiles. The power generation profile may be associated with a renewable energy source power profiles.

In one or more embodiments, the machine learning algorithm is implemented using artificial intelligence. The machine learning algorithm may be an algorithm that improves in its accuracy through experience. The machine learning algorithm may enable one or more embodiments to learn and improve from the forecasted weather condition data without explicit programming. The machine learning algorithm may be a neural network algorithm. The neural network algorithm may be trained to recognize complex patterns within the forecasted weather condition data and learn to represent non-linear relationships between the forecasted weather condition data and predicted power generation or demand profiles over time increments. The machine learning algorithm may be implemented as machine instructions on non-transitory memory stored on a computer where the machine instructions are to be executed by the computer.

The time increment may be any of the following values or in a range of any two of the following values: 1, 2, 3, 4, 5, 6, 7, 8, 9, 10, 11, 12, 13, 14, 15, 16, 17, 18, 19, 20, 21, 22, 23, 24, 48, 72, and 96 hours.

The geographic scale for the forecasted weather conditions may be but is not limited to a microscale (e.g., less than 1 kilometer), toposcale (e.g., 1 to 10 kilometers), and mesoscale (e.g., 10 to 1,000 kilometer). Computational fluid dynamics (CFD) may be used to model the forecasted weather condition data at the microscale and/or toposcale. Limited area models (LAMs) may be used to model the forecasted weather condition data at a mesoscale.

The forecasted weather condition may be wind. Where the forecasted weather condition is wind, the forecasted wind data may include, but is not limited to, wind speed, wind pressure, wind direction, wind gusts, and wind shear. Where the forecasted weather condition is wind, the historical power generation profile is historical wind power generation profile and the predicted power generation profile is a predicted wind power generation profile.

The forecasted weather condition may be solar. Where the forecasted weather condition is solar, the forecasted solar data may include, but is not limited to, solar irradiance, cloud cover, and temperature. Where the forecasted whether condition is solar, the historical power generation profile is historical solar power generation profile and the predicted power generation profile is a predicted solar power generation profile.

In one or more embodiments, the machine learning algorithm may use the forecasted wind data (e.g., wind speed and wind pressure) and be trained on historical turbine wind power generation profiles to obtain a predicted wind power generation profile. The machine learning algorithm may used forecasted solar data (e.g., solar irradiance and cloud cover) and be trained on a historical solar panel power generation profile to obtain a predicted solar power generation profile.

The predicted wind power generation profile and/or the predicted solar power generation profile may be coupled with a consumer power microgrid demand profile (e.g., a predicted profile based on historical data) to obtain a composite generation/demand profile. The composite generation/demand profile may be input a performance/degradation model of one or more system components coupled to a microgrid system (e.g., an electrolyzer stack, an energy storage system, etc.). An optimization algorithm may then be applied to the performance/degradation model(s) to derive one or more optimal power loads or other energy management optimization strategies with respect to one or more KPIs of the one or more system components coupled to the microgrid system. The one more optimal power loads output from the optimization algorithm may be transmitted to a microgrid controller. The microgrid controller may be electrically connected to one or more system components of the microgrid system.

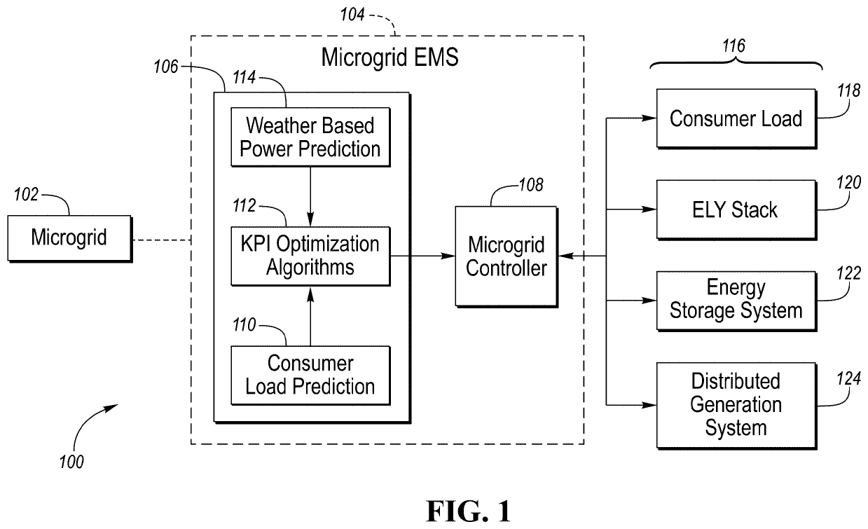

FIG. 1 depicts a schematic diagram of energy management system 100 according to one or more embodiments. Energy management system 100 includes microgrid system 102 and microgrid energy management system (EMS) 104. As depicted in FIG. 1, microgrid EMS 104 includes energy management controller 106 and microgrid controller 108. Energy management controller 106 and/or microgrid controller 108 may be electrically connected to microgrid system 102. Although the embodiment shown in FIG. 1 depicts energy management controller 106 and microgrid controller 108 as separate and distinct, these two controllers may be combined into a single controller in one or more embodiments.

As shown in operation 110 performed by energy management controller 106, a consumer load prediction is received by KPI optimization algorithm 112. As shown in operation 114 performed by energy management controller 106, a weather-based power prediction is received by KPI optimization algorithm 112. KPI optimization algorithm 112 is configured to determine an energy management optimization strategy. Energy management controller 106 is configured to transmit the energy management optimization strategy to microgrid controller 108.

As shown in FIG. 1, microgrid controller 108 is in electrical communication with system components 116 associated with microgrid 102. System components 116 include consumer load system 118, electrolyzer (ELY) stack 120, energy storage system 122, and distributed generation system 124. Consumer load system 118 may refer to a system configured to detect, determine, and/or supply electrical power to be consumed by consumer loads on a microgrid system. The types of consumer loads may include residential, commercial, industrial, and/or institutional loads. Distributed generation system 124 may refer to a system configured to manage the generation and distribution of electricity from several small, decentralized sources located close to where the power is generated. Consumer load system 118, electrolyzer stack 120, energy storage system 122, and distributed generation system 124 may include one or more controllers used to operate the system(s).

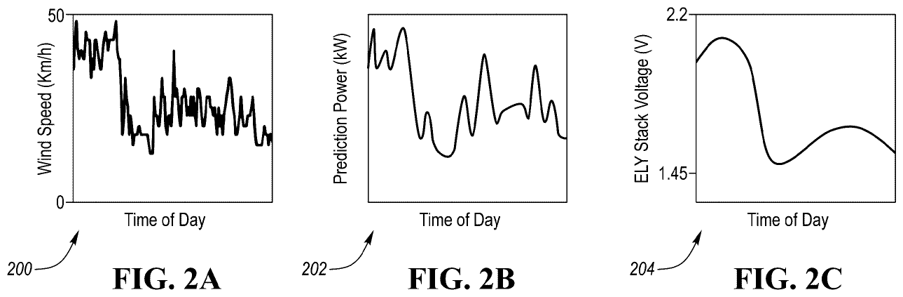

FIG. 2A depicts graph 200 of a wind speed forecast graphing wind speed (Km/h) as a function of time of day. The wind speed forecast may be input into an energy management system to optimize operation of one or more system components associated with a microgrid system.

FIG. 2B depicts graph 202 of a power generation profile graphing predicted power (kW) as a function of time of day. A machine learning algorithm may be used to predict the power generation profile in response to the wind speed forecast shown in FIG. 2A.

FIG. 2C depicts graph 204 implementing an optimal electrolyzer stack and energy management optimization strategy. Graph 204 plots electrolyzer (ELY) stack voltage (V) as a function of time of day. An optimization algorithm may be applied to one or more performance/degradation models to derive the operation strategy with one or more KPIs of the electrolyzer stack and the energy storage system.

According to one or more embodiments, the output from the optimization algorithm may be dynamically updated upon receiving further forecasted weather condition data. The optimization algorithm may be dynamically updated at successive time intervals. The successive time intervals may be any of the following values or in a range of any two of the following values: 1, 2, 3, 4, 5, 6, 7, 8, 9, 10, 11, 12, 13, 14, 15, 16, 17, 18, 19, 20, 21, 22, 23, 24, 48, 72, and 96 hours.

The energy management system may be used to improve hydrogen production of electrolyzer stacks by using renewable energy profiles, increasing efficiency, maintaining energy storage targets, limiting commitment of a microgrid system to peak-demand times, and/or reducing dynamic loading between high and low voltages. For example, in the case of incoming extreme weather events that may cause severe instability in renewable generation, excess energy storage capacity may be preemptively built up to ensure that the electrolyzer stack may be idled during the extreme weather condition rather bringing the electrolyzer stack to a hard shutdown.

In one or more embodiments, forecasted weather condition data is input into a \machine learning algorithm (e.g., a neural network) that predicts power generation of a wind turbine from wind speed and pressure data to predict one or more power generation profiles and expected consumer load profiles of intermittent renewable sources for a microgrid system \. The \ machine learning algorithm may be implemented on a controller. The controller may be configured to receive the forecasted weather condition data to predict a power generation profile. The controller may be electrically connected to one or more microgrid systems and/or one or more electrolyzer stacks. The controller may receive power predictions from any microgrid system in which it is connected. The power generation profile may be used as a design criterion for the design of an electrolyzer stack. An expected consumer load profile on the microgrid system may be estimated based on historical data (e.g., empirical or algorithmic historical data).

The machine learning algorithm may consider the dynamic nature of a number of renewable microgrids given the weather forecast to balance the power output from multiple microgrid systems with at least two different weather patterns in at least two different geographic areas. For instance, microgrid A in geographic area A may be in stable sun light during the day while microgrid B in geographic area B may be intermittently windy. The machine learning algorithm based on the weather forecasts of geographic areas A and B may be configured to adjust the power output to microgrid A and microgrid B to achieve a less dynamic but stable renewable electricity supply.

In one or more embodiments, a machine learning algorithm may determine an optimal electrolyzer stack operation strategy with respect to one or more prioritized KPIs in response to an expected power generation profile. The machine learning algorithm may also determine an optimal energy storage operation strategy with respect to one or more prioritized KPIs in response to a consumer load profile. The electrolyzer stack may be optimized for stable hydrogen production over longer periods of time with fewer interruptions in response to the weather forecast data. For instance, the weather forecast data and the algorithm may be used to predict the best time to charge the energy storage device. In other embodiments, the electrolyzer system may be optimized for maximizing hydrogen production rate when the renewable electricity cost is low with predicted dynamic output given the weather forecast.

In one or more embodiments, the energy management optimization strategy may be updated by a controller of the energy management system. For example, the electrolyzer stack operation strategy according to an updated predicted power generation profile and/or an energy storage system operation strategy according to an updated predicted power demand profile may be determined by the controller of an energy management system.

In one or more embodiments, a microgrid system may contain two or more electrolyzer stacks (e.g., an alkaline electrolyzer stack and a polymer electrolyte membrane (PEM) electrolyzer stack) with varying specifications having different KPIs and/or tolerances for dynamic operation. The machine learning algorithm may be configured to optimize the operation strategy of the two or more types of electrolyzer stacks to maximize efficiency and/or output while minimizing degradation of components of the electrolyzer stacks. For example, the combination of alkaline electrolyzer stacks to maintain relatively static operation at lower current densities and PEM electrolyzer stacks to handle the dynamic aspect of the power load is disclosed in one or more embodiments. This combination leverages the less expensive and lower durability alkaline electrolyzer stacks and the more expensive and more durable PEM electrolyzer stacks. The machine learning algorithm may then use the weather forecast and the power generation profile to optimize the power load of the two or more different types of electrolyzer stacks and an energy storage system. This optimization may be carried out on two or more competing objectives (e.g., simultaneously minimizing the total cost of hydrogen production and deprecation costs to maximize return on investment).

In one or more embodiments, the microgrid system may include an electrolyzer that generates hydrogen from electricity, a fuel cell and/or turbine that consumes hydrogen to generate electricity, and/or a hydrogen storage system. To extend the lifetime of an electrolyzer system including two or more electrolyzer stacks, a minimum current may be applied to each of the two or more electrolyzer stacks, resulting in a minimum voltage and hydrogen generation rate to reduce the aging rate even when renewable electricity is not available at the minimum current. Electricity may be supplied during one or more periods of no or low renewable power generation from a fuel cell or turbine, which itself is powered by hydrogen generated by the electrolyzer system. A hydrogen storage system may be used to buffer the overall microgrid and compensate for round-trip inefficiency of the electrolyzer and the fuel cell and/or the turbine.

The weather-related electricity supply and consumer-related demand forecasts may be used to predict the amount of hydrogen that should be stored in the hydrogen storage system to buffer the microgrid over the next time increment (e.g., minutes, hours, days, etc.) and/or an optimal load profile to produce that amount of hydrogen with respect to one or more prioritized KPIs. For example, the forecasted weather data may be used to predict a windmill power generation that enables prediction of a required amount of hydrogen to maintain a minimum current to an electrolyzer stack. The machine learning algorithm may then predict how to produce that amount of hydrogen while reducing or minimizing dynamic operation. The machine learning algorithm may be configured to co-optimize system efficiency and durability while accounting for the storage of hydrogen reducing the energy efficiency of the system.

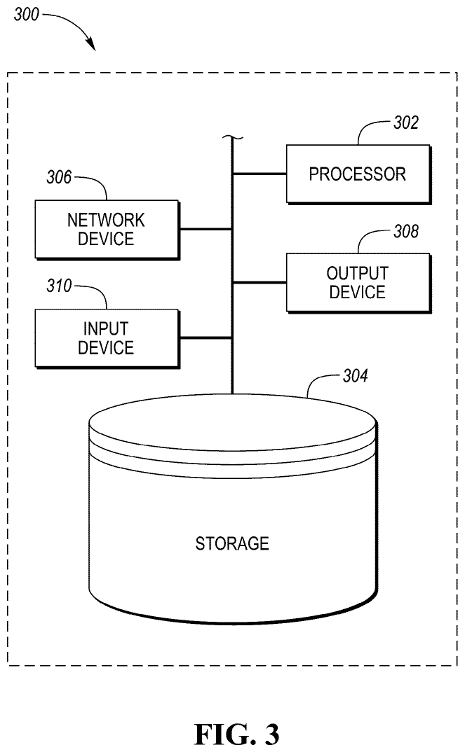

FIG. 3 depicts an exemplar computing device 300 that may be used in connection with an energy management system according to one or more embodiments. As shown, the computing device 300 includes processor 302 that may be operatively connected to storage 304, network device 306, output device 308, and input device 310. FIG. 3 denotes merely an example, and computing devices 300 with more, fewer, or different components may be used.

Processor 302 may include one or more integrated circuits that implement the functionality of a central processing unit (CPU) and/or graphics processing unit (GPU). In some examples, processors 302 may be a system on a chip (SoC) that integrates the functionality of the CPU and GPU. The SoC may optionally include other components such as, for example, storage 304 and network device 306 into a single integrated device. In other examples, the CPU and GPU may be connected to each other via a peripheral connection device such as peripheral component interconnect (PCI) express or another suitable peripheral data connection. In one example, the CPU may be a commercially available central processing device that implements an instruction set such as one of the x86, ARM, Power, or microprocessor without interlocked pipeline stage (MIPS) instruction set families.

In one or more embodiments, during operation processor 302 executes stored program instructions that may be retrieved from storage 304. The stored program instructions, accordingly, include software that controls the operation of processors 302 to perform the operations described herein. Processor 302 may execute machine learning algorithms (e.g., neural networks). Storage 304 may include both non-volatile memory and volatile memory devices. The non-volatile memory includes solid-state memories, such as not and (NAND) flash memory, magnetic and optical storage media, or any other suitable data storage device that retains data when the system may be deactivated or loses electrical power. The volatile memory includes static and dynamic random-access memory (RAM) that stores program instructions and data during operation of the machine learning algorithms of one or more embodiments. Network device 306 or other components of computing device may be in communication with one or more components (e.g., power storage and distribution systems).

Output device 308 may be configured to present data from one or more embodiments. Output device 308 may include a graphical or visual display device, such as an electronic display screen, projector, printer, or any other suitable device that reproduces a graphical display.

Input device 310 may include any of various devices that enable computing device 300 to receive control input from users. Input device 310 enables users to interact with the computing device, to configure an active machine learning process, to refine operational parameters of an active machine learning algorithm based on input. Examples of suitable input devices that receive human interface inputs may include keyboards, mice, trackballs, touchscreens, voice input devices, graphics tablets, and the like.

Network devices 306 may each include any of various devices that enable the devices to send and/or receive data from external devices over networks. Examples of suitable network devices 206 include an Ethernet interface, a Wi-Fi transceiver, a cellular transceiver, or a BLUETOOTH or BLE transceiver, UWB transceiver, or other network adapter or peripheral interconnection device that receives data from another computer or external data storage device, which may be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An energy management system comprising:
a controller configured to:
receive forecasted weather condition data;
predict a power generation profile and/or a power demand profile of a microgrid system in response to the forecasted weather condition data;
determine a performance model and/or a degradation model of one or more system components of the microgrid system in response to the power generation profile and/or the power demand profile;
deriving an energy management optimization strategy in response to the performance model and/or the degradation model of the one or more system components of the microgrid system; and
controlling an operation mode of the one or more system components of the microgrid system in response to the energy management optimization strategy.

2. The energy management system of claim 1, wherein the predicting step is performed by a machine learning algorithm.

3. The energy management system of claim 2, wherein the machine learning algorithm is a neural network.

4. The energy management system of claim 2, wherein the machine learning algorithm is trained on a historical power generation profile and/or a historical power demand profile to obtain the power generation profile and/or the power demand profile.

5. The energy management system of claim 1, wherein the deriving step is performed by an optimization algorithm.

6. The energy management system of claim 1, wherein the deriving step includes deriving the energy management optimization strategy in response to the performance model and/or the degradation model of the one or more system components of the microgrid system and one or more key performance indicators (KPIs) of the one or more system components of the microgrid system.

7. The energy management system of claim 6, wherein the one or more system components include an electrolyzer stack and the one or more KPIs include hydrogen production rate, production efficiency, mean time between failures (MTBF), mean time to repair (MTTR), stack lifetime, start-up time, turndown ratio, and/or power consumption at idle.

8. The energy management system of claim 6, wherein the one or more system components include an energy storage system and the one or more KPIs include nominal capacity, usable capacity, capacity degradation rate, maximum power output, response time, ramp rate, availability, mean time between failures (MTBF), mean time to repair (MTTR), and cycle efficiency.

9. The energy management system of claim 1, wherein the forecasted weather condition data is forecasted wind data, the forecasted wind data includes wind speed, wind pressure, wind direction, wind gusts, and/or wind shear.

10. The energy management system of claim 1, wherein the forecasted weather condition data is forecasted solar data, the forecasted solar data includes solar irradiance, cloud cover, and/or temperature.

11. The energy management system of claim 1, wherein the one or more system components includes an electrolyzer stack and/or an energy storage system.

12. The energy management system of claim 1, wherein the one or more system components is an electrolyzer stack and the power generation profile and/or the power demand profile is the power generation profile.

13. The energy management system of claim 1, wherein the one or more system components is an energy storage system and the power generation profile and/or the power demand profile is the power demand profile.

14. An energy management system comprising:
a controller configured to:
receive first forecasted weather condition data associated with a first microgrid system and second forecasted weather condition data associated with a second microgrid system;
predict a first power generation profile and/or a first power demand profile of the first microgrid system in response to the first forecasted weather condition data and a second power generation profile and/or a second power demand profile of the second microgrid system in response to the second forecasted weather condition data;
determine a first performance model and/or a first degradation model of the first microgrid system in response to the first power generation profile and/or the first power demand profile and a second performance model and/or a second degradation model of the second microgrid system in response to the second power generation profile and/or the second power demand profile;
derive an overall energy management optimization strategy for the first microgrid system and the second microgrid system in response to the first performance model and/or the first degradation model and the second performance model and/or the second degradation model; and
control a first operation mode of the first microgrid system and a second operation mode of the second microgrid system in response to the overall energy management optimization strategy.

15. The energy management system of claim 14, wherein the first microgrid system is in a first geographic area and the second microgrid system is in a second geographic area.

16. The energy management system of claim 14, wherein the overall energy management optimization strategy is configured to adjust a first power output to the first microgrid system and a second power output to the second microgrid system.

17. An energy management system comprising:
a controller configured to:
receive forecasted weather condition data associated with a microgrid system having a first electrolyzer stack of a first electrolyzer type and a second electrolyzer stack of a second electrolyzer type different than the first electrolyzer type;
predict a first power generation profile of the first electrolyzer stack in response to the forecasted weather condition data and the first electrolyzer type and a second power generation profile of the second electrolyzer stack in response to the forecasted weather condition data and the second electrolyzer type;
determine a first performance model and/or a first degradation model of the first electrolyzer stack in response to the first power generation profile and a second performance model and/or a second degradation model of the second electrolyzer stack in response to the second power generation profile;
derive an overall energy management optimization strategy for the first electrolyzer stack and the second electrolyzer stack in response to the first performance model and/or the first degradation model and the second performance model and/or the second degradation model; and
control a first operation mode of the first electrolyzer stack and a second operation mode of the second electrolyzer stack in response to the overall energy management optimization strategy.

18. The energy management system of claim 17, wherein the first electrolyzer type is an alkaline electrolyzer stack and the second electrolyzer type is a polymer electrolyte membrane (PEM) electrolyzer stack.

19. The energy management system of claim 18, wherein the first operation mode is a static operation mode.

20. The energy management system of claim 19, wherein the second operation mode is a dynamic operation mode.
